(19) United States
(12) Patent Application Publication
(10) Pub. No.: US 2019/0217538 A1
(43) Pub. Date: Jul. 18, 2019

(54) NOZZLE TECHNOLOGY FOR ULTRA-VARIABLE MANUFACTURING SYSTEMS

(71) Applicant: COBBLER TECHNOLOGIES, Bangor, ME (US)

(72) Inventors: Andrew Katon, Bangor, ME (US); Timothy Abraham, Bangor, ME (US)

(21) Appl. No.: 16/329,326

(22) PCT Filed: Aug. 29, 2017
(86) PCT No.: PCT/US2017/049088

§ 371 Date: Feb. 28, 2019

Related U.S. Application Data
(60) Provisional application No. 62/380,998, filed on Aug. 29, 2016.

(51) Int. Cl. B29C 64/209; B29C 64/393; B33Y 10/00; B33Y 30/00; B33Y 50/02

(52) U.S. Cl. CPC B29C 64/209; B29C 64/393; B33Y 50/02; B33Y 30/00; B33Y 10/00

(57) ABSTRACT

An atomized, functionally graded multi-material capable deposition apparatus, system and method is described. The deposition apparatus and system include a print nozzle and material delivery path to deposit material of varying characteristics. An internal chamber within the print nozzle receives the material under pressure and temperature control. An actuation mechanism within the print nozzle is used to control deposition of the material from the nozzle. A controller adjusts the temperature, pressure and actuation frequency based on material characteristics and print settings to precisely deposit the material in the form of an object.

### RELATED APPLICATIONS

This application incorporates by reference U.S. Provisional Application Ser. No. 62/380,998 entitled “DEPOSITION NOZZLE TECHNOLOGY FOR ULTRA-VARIABLE ADVANCED MANUFACTURING SYSTEMS” filed on Aug. 29, 2016.

### FIELD

The present inventive subject matter relates to the field of advanced manufacturing equipment and products made therefrom. More specifically, the present inventive subject matter relates to technology for deposition of materials within the field.

### BACKGROUND

Manufacturing

Mass manufacturing of foams, plastics and other similar materials is done generally through form extrusion, injection molding or other techniques requiring product-specific tooling and large production volumes. Even where machines can accommodate various forms and molds, change-over time and cost is still a concern and the cost and time to create of differing specific molds can make customization and variability quite difficult.

Modern piezoelectric actuation devices in the printing space are designed to jet low viscosity material at room temp. Managing high-viscosity, high-heat, and varying-characteristic materials presents a challenge.

Footwear

More and more attention is being given to health and fitness than ever before. This is partly due to inefficiencies in the healthcare system and increase in individuals wishing to take control of their own health. We are seeing increasing numbers of first time exercisers, who more often than not, end up with injuries.

In other fields, we see large numbers of workers, law enforcement, and military personnel who spend most of their day on their feet. This places a lot of stress on joints and tendons, often leading to injuries. Such injuries in turn lead to lost wages, reduction in productivity and increased cost for the individual, employer and government.

Shoes are primarily designed to protect the wearer's feet. This protection wears down over time and requires replacement. In the case of running shoes, most manufacturers suggest replacement every 300 miles. The main reason for this is that the shoe loses its ability to provide the appropriate level of shock absorption. This lack of shock absorption leads to greater strain on the wearer's joints and tendons, which in turn leads to injury.

### BRIEF DESCRIPTION OF THE DRAWINGS

Embodiments of inventive subject matter may be best understood by referring to the following description and accompanying drawings, which illustrate such embodiments. In the drawings:

FIG. 1 is a cutaway view of a deposition nozzle according to various embodiments.

FIG. 2 is a block diagram of a deposition system according to various embodiments.

FIG. 3 is a block diagram of a deposition nozzle system according to various embodiments.

FIG. 4 is a block diagram of an integrated nozzle deposition system according to various embodiments.

FIG. 5 is a side view of an auger delivery component according to various embodiments.

FIG. 6A is a block diagram of a deposition system utilizing auger delivery according to various embodiments.

FIG. 6B is a block diagram of a deposition system utilizing multiple auger delivery according to various embodiments.

FIG. 7A is a diagram of a deposition nozzle with mixing function according to various embodiments.

FIG. 7B is a diagram of a deposition nozzle with piezoelectric actuation according to various embodiments.

FIG. 7C is a diagram of a deposition nozzle with high pressure, high temperature, actuation assisted deposition according to various embodiments.

FIG. 8 is a block diagram of a piezoelectric deposition system with control according to various embodiments.

FIG. 9A is a cross-section diagram of a nozzle sealing system according to various embodiments.

FIG. 9B is a cross-section diagram of a rigid material based seal according to various embodiments.

FIG. 10 is a diagram of a nozzle system configured for variable control of multiple materials according to various embodiments.

FIG. 11 is a diagram of a multi-nozzle system according to various embodiments.

FIG. 12 is a block diagram of a deposition system utilizing post-nozzle mixing according to various embodiments.

FIG. 13 is a diagram of a deposition nozzle with integrated heating and cooling according to various embodiments.

FIG. 14 is a flow diagram of an atomized deposition process according to various embodiments.

### DESCRIPTION

In the following description, reference is made to the accompanying drawings that form a part hereof, and in which is shown by way of illustration specific embodiments which may be practiced. These embodiments are described in sufficient detail to enable those skilled in the art to practice the present subject matter, and it is to be understood that other embodiments may be utilized and that structural, logical and electrical changes may be made without departing from the scope of the present subject matter. The following description of example embodiments is, therefore, not to be taken in a limited sense, and the scope of the present invention is defined by the appended claims.

According to various embodiments of the inventive subject matter, Atomized Particle Deposition APD technology takes in one or multiple material feeds, mixing if necessary, then atomizes the material (breaks the material into small components or droplets) using pneumatic, sonic, piezoelectric or other agitation methods along with temperature and pressure control. Configuration of the agitation, deposition, temperature and pressure, along with other system variables is set based on the characteristics of the material(s) in process (or combinations thereof). The result is a finely controlled application of material of a desired composition at high resolution.

An atomized particle deposition nozzle technology enables a printer to deposit customized layers of finely controlled material in varying concentrations in three dimensions. Fine particles or droplets are ejected from the nozzle, providing a smooth surface finish in comparison to many other 3D-printing technologies available in the market. Printing nozzles draw multiple raw materials from supply reservoirs allowing for on-the-fly material changing and mixing between and between and within printed layers. Multiple nozzles are used to increase print speed and material resolution.

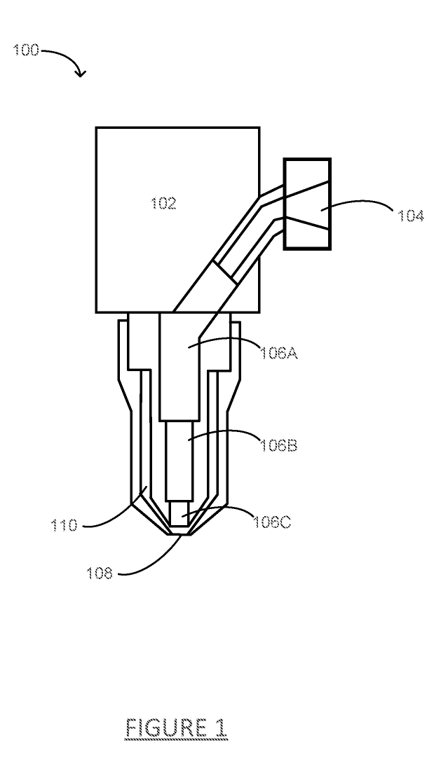

FIG. 1 is a cutaway view of a deposition nozzle 100 according to various embodiments. The deposition nozzle 100 includes a nozzle body 102, a fluid inlet 104, fluid passage 106A-C, spray tip 108, and high pressure air chamber 110.

The deposition nozzle 100 will receive a material at the fluid inlet 104. Pressure being applied to the material as it flows into the fluid inlet 104 will force the material into the fluid passage 106A. In order to prepare the material for deposition, the fluid passage 106A may taper down into smaller and smaller cross-section fluid passages 106B-C. The nozzle body 102 may include mechanisms to control the outflow of the material through the spray tip 108. Example control mechanisms may include a diaphragm or piston system, hydraulically or pneumatically controlled pins, needles (e.g. needle valves), or other devices to restrict or allow material passage from the fluid passage 106A-C through the spray tip 108 for deposition.

According to various embodiments, the deposition nozzle includes an atomization characteristic/functionality in order to break up the material as it exits the spray tip 108. A high pressure air chamber 110 is supplied with high pressure from an external source. This high pressure air chamber is shaped in such a way with respect to the deposition nozzle 100 so as to collide the high pressure air with the material exiting the spray tip in order to cause atomization. Atomization being defined as breaking apart the material in such a way to reduce the material to a fine mist. FIG. 1 depicts the high pressure air chamber 110 as being integral to the deposition nozzle 100, but according to other embodiments, high pressure air may be delivered from an external mechanism to direct a stream of air (or other gas) at the material exiting the spray tip 108. In yet other embodiments, the atomization characteristic may be comprised of an ultrasonic transducer or piezoelectric actuator to provide a vibratory atomization. The described atomization characteristics may be used singly or in concert according to varying embodiments.

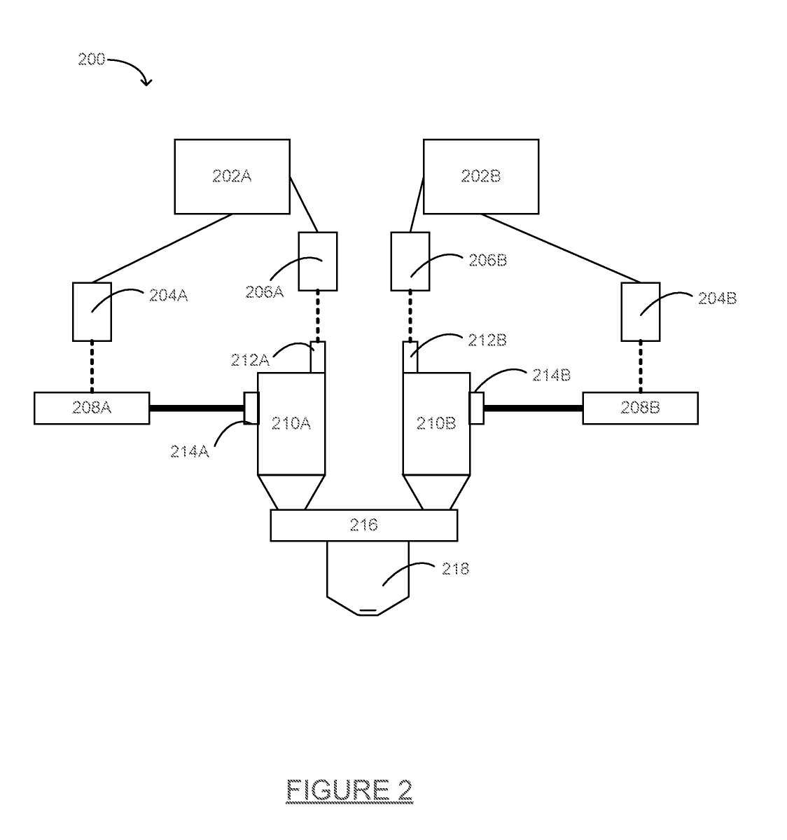

FIG. 2 is a block diagram of a deposition system 200 according to various embodiments. The deposition system 200 includes controllers 202A-B, fluid supply valves 204 A-B, fluid control valves 206A-B, reservoirs 208A-B, fluid delivery valves 210A-B having fluid inlets 214A-B and control interfaces 212A-B, mixing chamber 216 and nozzle tip 218.

The deposition system 200 supports the utilization of multiple materials. Each material is stored in a reservoir 208A-B. According to various embodiments of the present inventive subject matter, the purpose of the varying materials within the deposition system 200 is to allow:

A) The separate deposition of varying materials. This may be used to deposit a support material and a structural material separately in order to deal with overhangs or the like. It may also be used to build a structure which simply utilizes multiple materials.

B) The deposition of a mixed combination of multiple materials. This may be used to deposit varying or graded materials through the axes of the print.

FIG. 2 illustrates a deposition system 200 for handling two materials, but it is within the inventive subject matter that more materials may be used in the deposition 200 by the addition of one or more of the repeated elements.

Referring to the delivery process of one of the materials in the deposition system 200, controller 202A controls the actuation of the fluid supply valve 204A. The opening of the fluid supply valve provides pressure upon the material in the reservoir 208A. The reservoir 208A may include a bladder, piston or other mechanism to allow pressure to be provided in order to move the enclosed material out and toward the fluid delivery valve 210. According to various embodiments, pneumatic pressure is applied utilized to move the material in the reservoir 208A, although other alternatives are considered, such as hydraulic, or pressure created from an electronically controlled mechanism (e.g. linear actuator). In some embodiments, a static pressure is applied to the reservoir 208A, and a fluid supply valve may not be utilized.

Once the material flows from the reservoir it enters the fluid delivery valve 210A. The fluid delivery valve is a mechanism which controls the flow of the material as it is to be deposited. The controller 202A utilizes a fluid control valve 206A to achieve this goal. According to various embodiments, the fluid control valve 206A is a pneumatic valve; a control signal from the controller 202A directs the fluid control valve 206A to open or close. Opening of the fluid control valve 206A will send pressurized air to the fluid delivery valve 210A. Mechanisms within the fluid delivery valve 210A will selectively allow the passage of the material based on the air pressure supplied from the fluid control valve 206A. In this manner, the deposition system 200 maintains precision control of the timing and volume of material delivered from the fluid delivery valve 210A.

A similar process is utilized for one or more other materials within the depositions system 200. The multiple materials may be deposited serially. In order to obtain precise serial deposition of multiple materials using a single nozzle tip 218, the controller(s) 202A-B take into account the volume of a first material currently being deposited, and when a second material is needed to be deposited.

The multiple materials may also be deposited in combination. Mixtures of a first material and a second material (and more as needed) may be created on the fly by controlling the material delivery speed and volume of each material. As the materials exit their respective e fluid delivery valves, they are mixed in the mixing chamber 216 as they are delivered to the nozzle tip 218 for deposition. In order to get desired gradations or concentrations of materials at various points in a print, the controller(s) 202A-B take into consideration the current mixture in the mixing chamber 216. The current mixture in the mixing chamber 216 is calculated by taking into account the volume of space over which material must travel after it has passed the fluid delivery valve 210A and the rate at which material is deposited. The controller(s) 202A-B will then adjust the material delivery characteristics with this offset in consideration. The material delivery characteristics include temperature, pressure and fluid control. The controller(s) 202A-B may also take into consideration specific material characteristics in order to set the framework within which the material delivery characteristics impact deposition volume and flow rates.

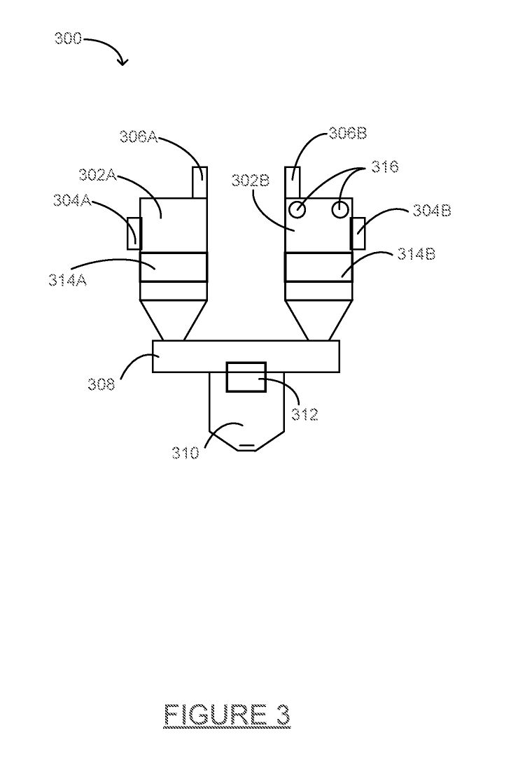

FIG. 3 is a block diagram of a deposition nozzle system 300 according to various embodiments. The deposition nozzle system 300 includes delivery valves 302A-B with fluid inlets 304A-B and control inputs 306A-B, mixing chamber 308, nozzle tip 310, and atomization characteristic 312.

The delivery valves 302A-B may also include integrated or external heating elements 314A-B, depending of the type of material which will be flowing through. If the material is in liquid form at or around room temperature, such heating elements 314A/314B may not be utilized. Additionally, according to various embodiments, the delivery valve 302B is shown with cooling channels 316. The cooling channels are used to temper any heat which may be provided by the material or heating element 314B to protect heat sensitive elements of the delivery valve 302B. The cooling channels 316 may be supplied with a fluid circulated through the channels and recoiled externally to maintain desired temperature for components in the delivery valve 302.

The deposition nozzle system 300 is illustrated as a block diagram with separate parts, but it is considered within the scope of the inventive subject matter that any of the described components may be integral to one-another. In this way, for example, the mixing chamber 308 need not be a separate component from the delivery valves 302A-B, but instead may be an integral chamber connecting the delivery valves 302A-B. Similarly, heating elements 314A/314B may be a single element encompassing integrally connected delivery valves 302A-B.

According to various embodiments, the atomization characteristic 312 is an external or integral mechanism that acts to break apart the material as it flows thorough the deposition nozzle system 300 and out the nozzle tip. This atomization characteristic 312 may be vibratory in nature (e.g. ultrasonic), breaking up the material through high frequency vibration. The atomization characteristic 312 may be pneumatic in nature, providing one or more jets of high pressure air to break up the material as it exits the nozzle tip 310. The atomization characteristic may be agitative in nature, utilizing a mechanical/electrical actuator to break up the material as it exits. A piezoelectric actuator, for example provides an agitator/vibratory atomization characteristic 312 to a deposition nozzle system, allowing for the deposition of miniscule droplets of material, with droplet size/volume depending at least partially on the actuation frequency of the piezoelectric. In this way, an actuator based arrangement can provide both an atomization characteristic as well as flow control by allowing the mechanical element of actuation to constrict material flow.

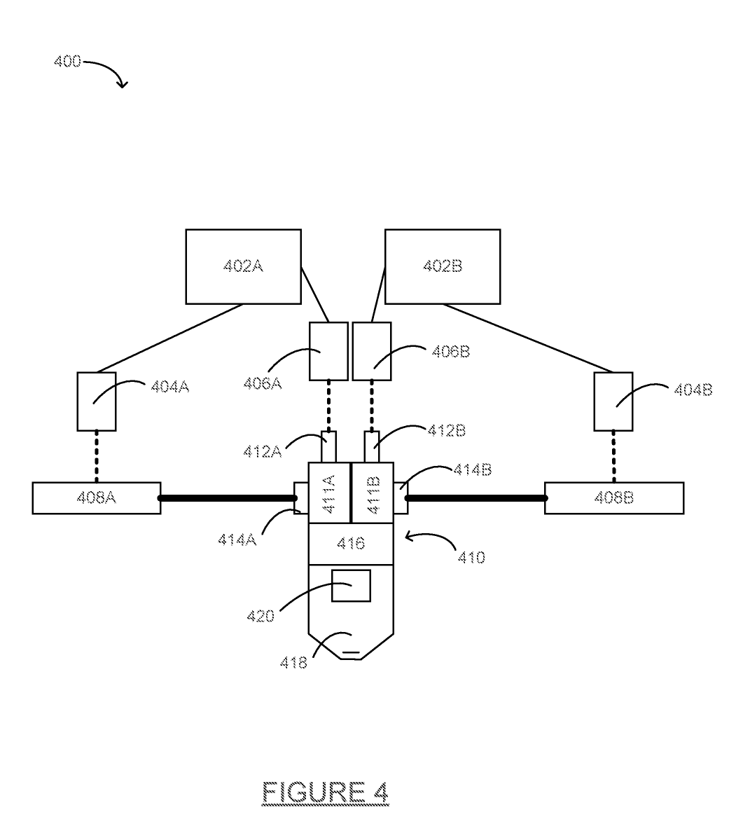

FIG. 4 is a block diagram of an integrated nozzle deposition system 400 according to various embodiments. The integrated nozzle deposition system 400 includes controllers 402A-B, fluid supply valves 404 A-B, fluid control valves 406A-B, reservoirs 408A-B, deposition nozzle 410 having fluid inlets 412A-B, control interfaces 414A-B and fluid control mechanisms 411A-B, mixing chamber 416 and nozzle tip 418.

According to various embodiments, the deposition nozzle 410 also includes an atomization characteristic 420. In some embodiments, the atomization characteristic 420 is provided by an ultrasonic transducer which provides high frequency vibration sufficient to break up the material as it flows through and exits the nozzle tip 418. In other embodiments, the atomization characteristic 420 utilizes high pressure air or other gas to agitate and break up the material as it flows through and exits the nozzle tip 418.

According to various embodiments, the fluid control valves 406 may be integrated into the deposition nozzle 410 and fluid control mechanisms 411A-B. External fluid control valves 406A-B support pneumatically or hydraulically controlled fluid control mechanisms 411A-B. Fluid control valves 406A-B integrated with the fluid control mechanisms 411A-B allow for direct electronic control of the fluid flow in the deposition nozzle 410.

According to various embodiments, the atomization characteristic 420 and/or other additional agitation mechanism is/are used to assist in material combination within the mixing chamber 416 as materials pass through the deposition nozzle before exiting the nozzle tip 418. This additional agitation aids in improving the consistency of the mixed combination and helps ensure that the material combination being deposited at a given time is as desired.

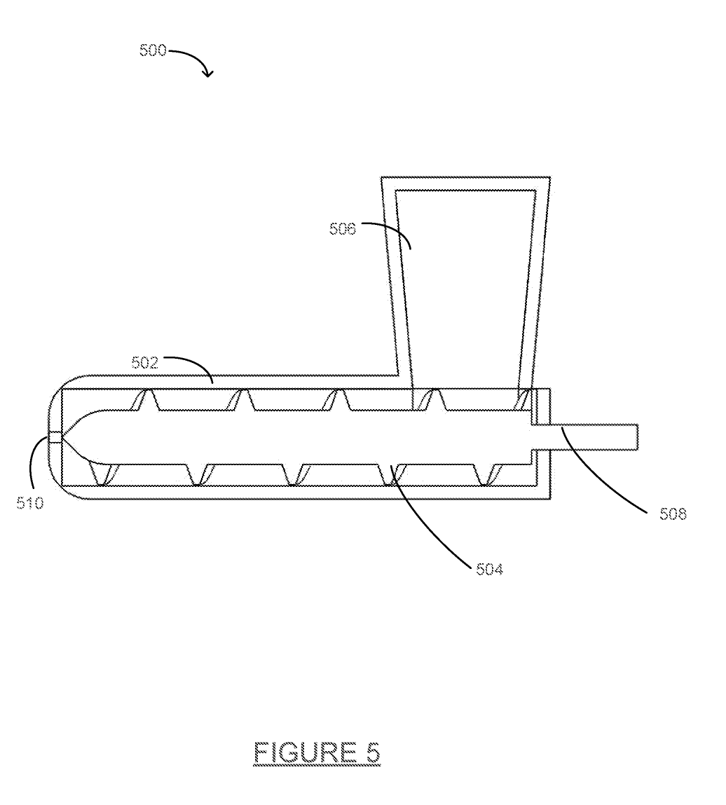

FIG. 5 is a side view of an example auger delivery component 500 according to various embodiments. The auger delivery component 500 includes a body 502 enclosing a chamber housing an auger 504, hopper 506, auger shaft 508 and material outlet 510.

Material is provided to the auger delivery component 500 via the hopper 506. In some example embodiments, the hopper 506 may be an open vessel similar to as illustrated in FIG. 5. In other embodiments, the hopper 506 may be an enclosed chamber with one or more material inlet ports. The hopper 506 serves as a place for gather material as it is being delivered to the auger 504. The auger 504 is positioned within a channel in the body 502. The auger 504 is designed to rotate along its major axis within the channel. Such rotation causes material from the hopper 506 to move along the auger 504 within the channel and away from the hopper 506. The auger terminates at the material outlet 510—an aperture in the body 502 which allows the material being moved by the auger 504 to be pushed out of the body 502 for delivery to another component in a deposition system.

The auger delivery component 500 may be used to move a single material. Alternatively, the auger delivery component 500 may be used to move a mixed combination of materials, in which case, the motion of the materials across the auger 504 aids in the mixing of the materials.

According to alternative embodiments, the auger 504 and/or body 502 may be shaped so as to taper along the major axis in order to provide desired material delivery and pressure characteristics.

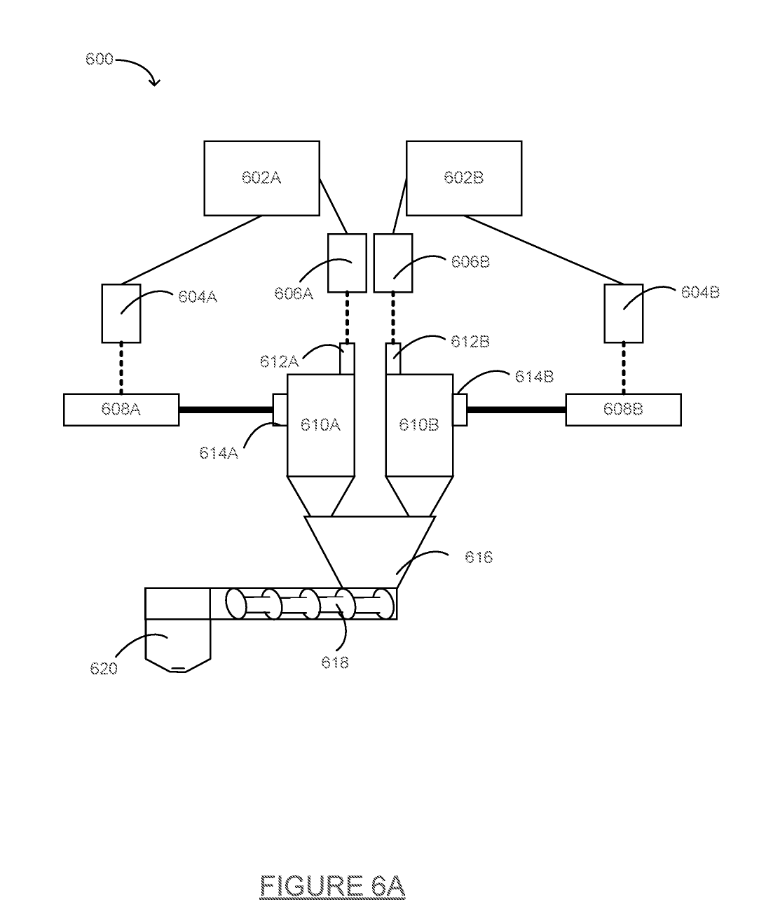

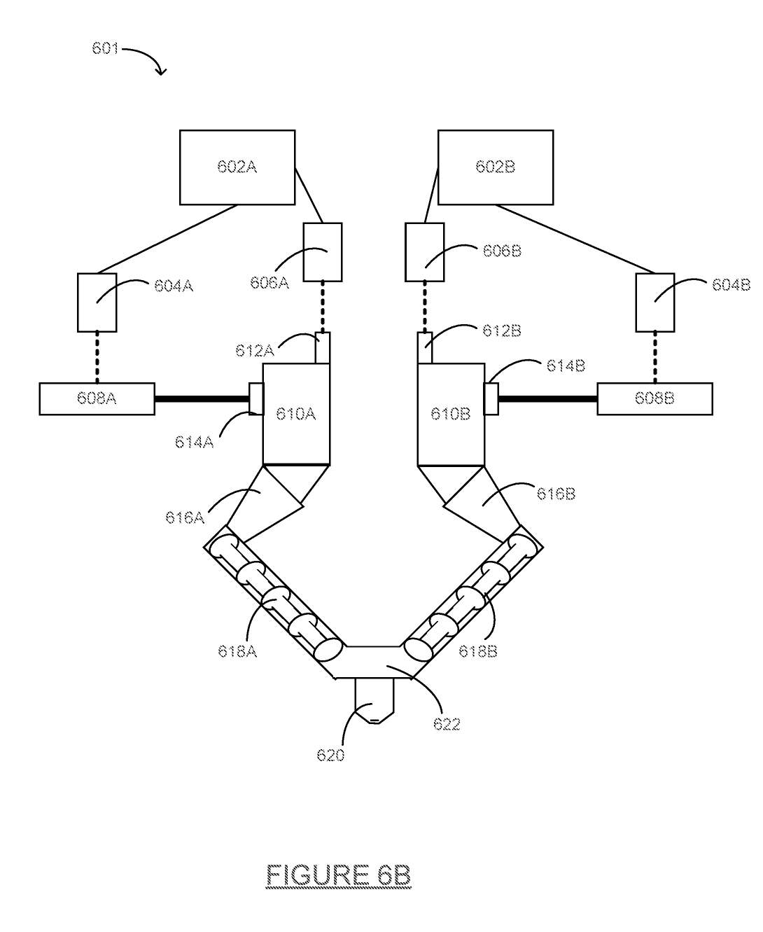

FIG. 6A is a block diagram of an auger delivery deposition system 600 according to various embodiments. The auger delivery deposition system 600 includes controllers 602A-B, supply valves 604 A-B, control valves 606A-B, reservoirs 608A-B, material delivery valves 610A-B having inlets 614A-B and control interfaces 212A-B, hopper 616, auger 618 and deposition nozzle 620.

Similar to deposition systems of FIG. 2 (200) and FIG. 4 (400), the auger delivery deposition system 600 utilizes controllers 602A-B, supply valves 604 A-B, control valves 606A-B, reservoirs 608A-B, and material delivery valves 610A-B. Once the material flows through the material delivery valves 610A-B, it enters the hopper 616 of the auger mechanism. Hopper 616 may be integral to the material delivery valves 610A-B, or may be a separate component in fluid communication. Material in the hopper is allowed to mix, if desired, as it is fed into the auger 618 to get further mixed and pushed toward the deposition nozzle 620. According to some embodiments, the auger 618 can provide material to the deposition nozzle 620 at high pressure in excess of 100 psi so that viscous shear thinning materials may be more easily and precisely atomized for deposition. Atomization characteristics as described herein may be utilized by this auger delivery deposition system 600 in particular in the deposition nozzle 620.

FIG. 6B is a block diagram of a deposition system 601 utilizing multiple auger delivery according to various embodiments. The deposition system 601 includes controllers 602A-B, supply valves 604 A-B, control valves 606A-B, reservoirs 608A-B, material delivery valves 610A-B having inlets 614A-B and control interfaces 212A-B, hoppers 616A-B, augers 618A-B, mixing chamber 622 and deposition nozzle 620.

Deposition system 601 operates similarly to auger delivery deposition system 600 of FIG. 6A, except that instead of the material delivery valves 610A-B feeding into the same auger mechanism, each material delivery valve 610A-B feeds into its own hopper 616A-B and auger 618A-B before being combined at pressure in the mixing chamber 622. In some example embodiments, agitation mechanisms may be used in the mixing chamber 622 to aid in the combination of the materials. In other embodiments, the mixing chamber may be eliminated (or merely integrated into the deposition nozzle 620), wherein material from the augers 618A-B would flow directly to the deposition nozzle 620. In some embodiments, atomization characteristics in the deposition nozzle (vibrational mechanisms for example) are used to assist in mixing before atomization at deposition.

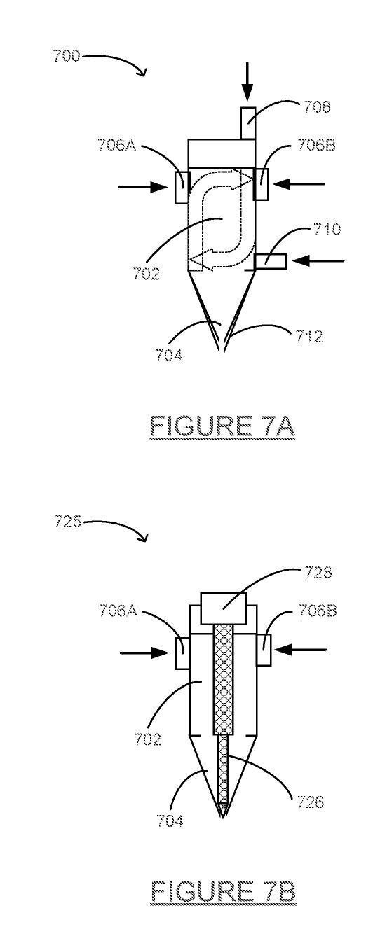

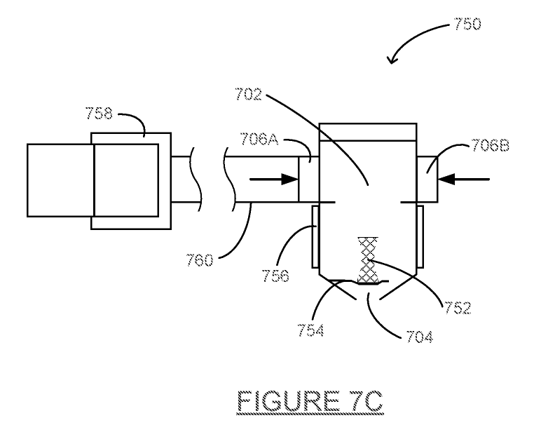

FIG. 7A is a diagram of a deposition nozzle 700 with mixing function according to various embodiments. The deposition nozzle 700 includes body chamber 702, nozzle tip 704, material inlets 706A-B, control input 708, and atomization input 710.

The deposition nozzle 700 receives one or more materials through the material inlets 706A-B. The material enters the body chamber 702 where it may be subject to agitation. According to various embodiments, high pressure air (or other gas) is injected into the body chamber through the atomization input 710. If multiple materials are present in the body chamber 702 (from material inlets 706A, 706B), this high pressure air serves to help mix and combine the varying materials. The air also helps to break up and thin the material for easier deposition. Control input 708 received signals (electrical, pneumatic, hydraulic, for example) which are used to control flow of the material in the body chamber 702 out through the nozzle tip 704. According to various embodiments, actuation or valve operation is used to allow the exit the nozzle tip 704. The control input 708 receives such signals from a controller which is programmed to provide such signals in order ensure material is deposited in desired amounts, quantities and at the appropriate time, taking into consideration the material concentrations expected to be present in the body chamber 702 and along material delivery channels.

According to various embodiments, nozzle tip 704 includes air channels 712 for high pressure air (or other gas) to contact the material as it exits the nozzle tip 704 in order to atomize the material for deposition. According to other embodiments, high pressure air may be delivered to material exiting the nozzle tip 704 from an external mechanism to direct an atomizing stream of air (or other gas) at the material as it exits.

FIG. 7B is a diagram of a deposition nozzle 725 with actuation according to various embodiments. The deposition nozzle 725 includes body chamber 702, nozzle tip 704, material inlets 706A-B, nozzle needle 726 and actuator 728.

The deposition nozzle 725 receives one or more materials through the material inlets 706A-B. If multiple materials are received, they are combined in the body chamber 702. According to other embodiments, multiple materials being delivered concurrently may be combined before entering the deposition nozzle 700, in which case they will enter through a material inlet 706A-B and into the body chamber 702 with a pre-mixed concentration. Additional mixing will generally occur in the body chamber 702, especially when the actuator 728 is in operation—which in come embodiments adds a vibratory force upon the material. Material in the body chamber is pushed to the nozzle tip 704, where it meets a restriction based on the size of the deposition aperture or orifice in the nozzle tip 704, and the presence of the nozzle needle 726 in the nozzle tip orifice. The nozzle needle 726 is controlled by the actuator 728. Activation of the actuator 728 moves the nozzle needle 726 about the nozzle tip orifice, allowing and restricting flow of the material out of the nozzle tip 704 at a rate controlled by the frequency of the actuation. The movement of the nozzle needle 726 serves to both control material flow (like a needle valve) as well as agitate/atomize the material as it exits the nozzle tip 704. High frequency movement (vibration) of the nozzle needle 726 applies shear forces upon the material, and adjustment of the frequency effects the material flow rate and droplet size.

According to various embodiments, the material composition of the nozzle needle 726 is a metal or metal alloy with sufficient strength and heat tolerance. A tungsten carbide nozzle needle 726 provides hardness, resistance to scratching and abrasion, and heat resistance. A ceramic nozzle needle 726 utilizes more precision movement, seals and channels due to the brittle nature of the material, but provides enhanced heat tolerance. Other example materials include Ceramic Matrix Composites (CMC), Silicon Carbide, and others. In some embodiments, a metallic or conductive nozzle needle 726 is employed with a similarly nozzle tip 704 having conductive material such that electrical circuitry in communication with the nozzle needle 726 and the nozzle tip 704 may sense contact between the two for a determination of when the nozzle needle is actuated into a closed position. This determination is used for configuration or adjustment of the actuation.

According to another embodiment of the inventive subject matter, a hybrid of the deposition nozzle of FIG. 7B (725) and the deposition nozzle of FIG. 7A (700) is described. In this hybrid arrangement, an actuator 728 moves the nozzle needle 726 within a nozzle tip 704 to control the flow of material through the nozzle. Air channels 712 in the nozzle tip 704 serve to deliver jets of air (or other gas such as nitrogen) to break apart droplets of material as they are released from the nozzle tip 704. The hybrid action of the piezoelectric actuation of the nozzle needle 726 and the air from the air channels 712 allow the droplets of material to be delivered from the nozzle in an atomized (or sufficiently small) nature to allow for higher resolution printing and enhanced bonding between layers and materials of varying composition.

FIG. 7C is a diagram of a deposition nozzle 750 with high-pressure, high-temperature, actuation-assisted deposition according to various embodiments. The deposition nozzle 750 includes body chamber 702, nozzle tip 704, material inlets 706A-B, actuation element 752, vibration plate 754, heating element 756, material supply chamber 758, and fluid channel 760.

The body chamber 702 is arranged to receive one or more materials at a time through the material inlets 706A-B. Materials may be delivered serially or in parallel. A material is provided to a material inlet 706A through the fluid channel 760 from the material supply chamber 758. The material supply chamber 758 and fluid channel are provided with heating or insulation sufficient to maintain the material within in a liquid state. Material supply chamber 758 includes a pressurizing element in order to move material from the material supply chamber 758 through the fluid channel 760, nozzle body and to the nozzle tip 704. The provided pressure is used to not only move the material but also to take advantage of shear thinning characteristics of viscous liquids. The higher pressure imparted upon shear thinning materials allows for easier viscous droplet formation by applying rapid shear forces upon the material. The thinner the material the easier it is to break up.

According to some embodiments, heating elements are also provided and utilized based on the thermal characteristics of the material(s) being processed through the deposition nozzle 700. The temperature of the heating elements may be adjusted by a controller in coordination with material or material concentrations passing through the body chamber (or other heated components of the system).

The actuation element 752 may be electrically controlled by a controller in the system, and is used to atomize (break-up) the material and also push it out through the nozzle tip in the form of miniscule spray droplets. According to various embodiments, the actuation element 752 acts on the material directly—it is in contact with the material and its movements or deformations directly impact the material. According to other embodiments, the actuation element is aided by a vibration plate 754 which moves in concert with the changes in the actuation element 752.

According to various embodiments of the inventive subject matter, the actuation element is piezoelectric in nature. As a piezoelectric device, the actuation element 752 may include a bimorph actuator or bender. According to other embodiments, the piezoelectric actuation element 752 includes expanding piezoceramic stacks providing high forces (which add pressure desirable for dealing with shear thinning materials) and quick agitation (desirable for atomization of those thinned materials). According to yet other embodiments, the piezoelectric actuation element 752 includes shear actuators to pull material and push through the nozzle tip 704 while leverage rapid actuation to achieve atomized droplet/spray formation.

The combined and controlled use of heat to melt the material into a liquid state, pressure to take advantage of shear thinning characteristics and reduce viscosity, and rapid actuation to apply the agitating shear forces and output control allow for precise viscous droplet formation of materials otherwise unwieldly in additive manufacturing deposition systems.

Piezoelectric valve actuation as employed by the actuation element according to various embodiments, is an effective method of material droplet formation. The actuation element 752 is used to open and close small valves in the nozzle tip 704 thousands of times a second. This frequency, measured generally in Hz also rapidly induces shear forces on a liquid material and allows precise amounts of that liquid to pass while the valve is in the open position. This shear force decreases fluid viscosity and increases flowrate at comparable operating pressures and temperatures. When a shear force is induced on the liquid the flow properties of that liquid dynamically change. Implementations on high viscosity EVA rubber show dramatic flowrate increases with in a system employing high heat, pressure and piezoelectric induced shear forces. With the ability to feed fluids with high pressure (on the order of 1,000 psi+) the deposition nozzle 750 and related system provides precision atomization of viscous shear-thinning materials.

With control over the temperature, pressure and agitation/atomization frequency, deposition resolution is limited primarily by size of the deposition aperture in the nozzle tip 704.

According to other embodiments of the inventive subject matter, thermal transduction or acoustic wave based actuation are used as the actuation element 752.

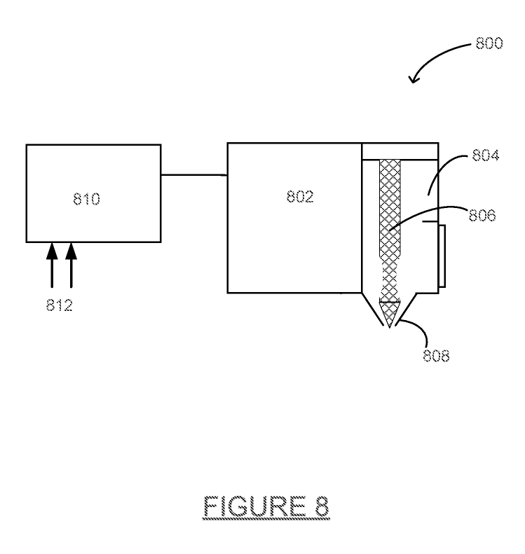

FIG. 8 is a block diagram of a piezoelectric deposition system 800 according to various embodiments. The piezoelectric deposition system 800 includes a piezoelectric actuator 802, body 804, needle 806, nozzle tip 808, controller 810 and inputs 812.

According to various embodiments, the piezoelectric actuator 802 moves the needle 806 within the body 804 to open and close an orifice in the nozzle tip 808. The needle 806 is in communication with the piezoelectric actuator at or near one end (longitudinal), while the opposite end serves to seal or open the nozzle tip 808. The frequency of actuation is controlled by the controller 810. The controller 810 communicates with the piezoelectric actuator 802 to configure, adjust and control actuation frequency as well as frequency acceleration and deceleration. Depending on the characteristics of the object being printed (material type, material mixture, shape, resolution, and others), print characteristics including print speed, temperature and others, the piezoelectric actuation frequency and change in actuation frequency are adjusted to allow for a desired deposition of material. The controller 810 may be hardware circuit based, software based or a combination thereof.

According to some embodiments, adjustable frequency control of the piezoelectric actuator 802 by the controller 810 allows for traditional fused deposition modeling (FDM) acceleration algorithms to be utilized with a piezoelectric actuated 3DAPD system. This is effectuated by translating the FDM acceleration algorithms into piezoelectric frequency control signals.

According to various embodiments, the frequency of the piezoelectric actuator 802 affects the flow and movement of material through the nozzle tip 808. The movement of the needle 806 at particular frequencies also serves to break up the material into droplets. Higher frequency equates to smaller droplets at a higher speed. The shear forces applied to the material by the needle 806 as it is actuated also serves to reduce the viscosity of certain materials. This arrangement allows for reduced droplet/pixel size in the workpiece while being able to control speed and material deposition volume in accordance with the print object characteristics.

The controller 810 receives data via the inputs 812. These inputs 812 deliver data regarding the object being printed from external software/computing device(s). According to additional embodiments, the inputs 812 include data from sensors monitoring printer characteristics, print object characteristics and/or environmental characteristics. Printer characteristics can include vibration, temperature, component location, and other characteristics of the printer and its mechanical/structural components. Object characteristics can include location, shape, temperature and other characteristics of the object being printed, which may be measured optically, thermally or otherwise. Environmental characteristics can include ambient temperature, humidity, barometric pressure, air movement and other characteristics of the ambient space about the printer.

According to some embodiments, an accelerometer or other inertial sensing device is connected to the controller 810 through inputs 812. The controller 810 can use the accelerator to calibrate the piezoelectric actuator 802 and configure against vibration. When dealing with materials with variable viscosity, the controller can adjust pressure, temperature print speed and height to obtain a print to specifications.

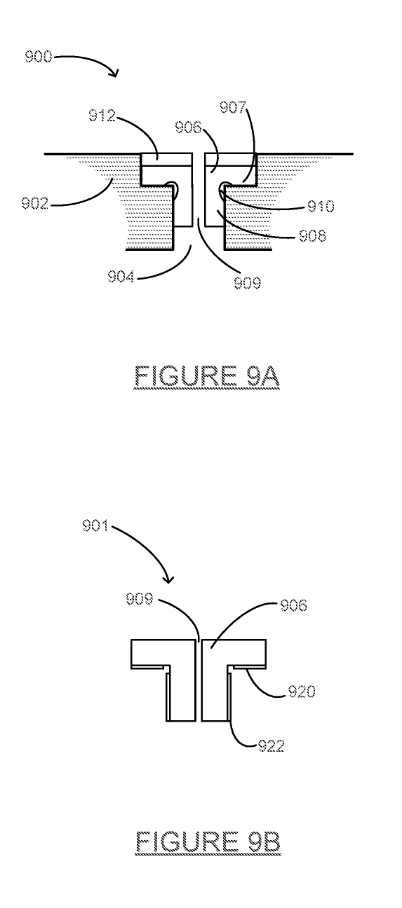

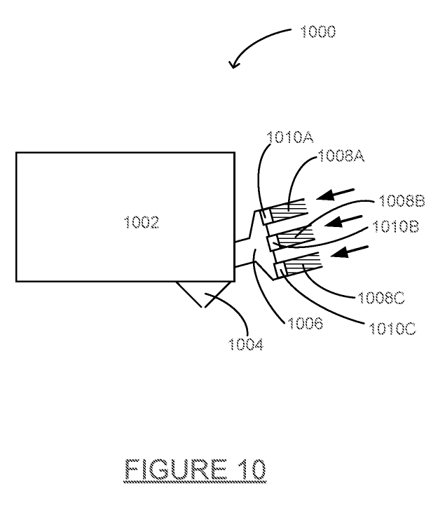

FIG. 9A is a cross-section diagram of a nozzle sealing system 900 according to various embodiments. The nozzle sealing system 900 includes nozzle body 902, fluid chamber 904, seal body 906, and seal spacer 912.

The seal body 906 includes an overhang 907, vertical 908 and needle aperture 909. The seal body 906 is located in a cavity in the nozzle body 902, allowing the overhang 907 to sufficiently contact the nozzle body 902 to securely hold the seal body 906 in place. The seal spacer 912 is used to provide pressure against the seal body 906, securing it within the nozzle body 902. According to various embodiments, the seal spacer 912 is made out of a high pressure, high-heat, low-friction polymer. Examples include VESPEL, CELAZONE, and in certain circumstances even a non-polymeric material like ceramic. In other embodiments, the seal spacer 912 is integral to the seal body 906 and not a separate component. The interface between the overhang 907 and the nozzle body 902 provides a tight seal against fluid movement. The vertical 908 of the seal body 906 interfaces with sidewalls of an aperture in the nozzle body 902 to provide seal alignment. Needle aperture 909 extends through the seal body to allow a nozzle needle to pass through. The ability of the vertical 908 to allow the seal body 906 to have alignment within the nozzle body 902 in turn allows a nozzle needle to consistently move within the needle aperture 909 with desirable tight tolerances.

According to various embodiments, the seal body 906 has a flared in portion 910 at the interface between the overhang 907 and the vertical 908. This flared in portion 910 creates a gap or removes an area of contact between the seal body 906 and the nozzle body 902. By removing this area of contact, the seal body 906 is able to be seated within the nozzle body 902 with improved alignment. The absence of a contact point at the flared portion 910 removes the necessity for a perfect 90 degree, or perfect corner match at the interface between the vertical 908, the overhang 907 and the nozzle body 902. Engineering a perfect 90 degree interface can be difficult and generally some radius is left at the interface between the overhang 907 and vertical 908. The presence of a radius at this point prevents the overhang 907 or the vertical 908 from having ideally aligned interfaces with the nozzle body 902, resulting a non-ideal seal and mis-aligned aperture 909.

According to some embodiments, the gap between the seal body 906 and nozzle body 902 caused by the flared portion 910 is filled with fluid material travelling through the nozzle. The symmetry of the gap as it is filled with fluid on an initial use of the nozzle aids in the security and alignment of the seal body 906.

FIG. 9B is a cross-section diagram of a rigid material based seal 901 according to various embodiments. The rigid material based seal 901 includes a seal body 906 having a needle aperture 909, a horizontal contact rubber coating 920 and a vertical contact rubber coating 922.

According to various embodiments, the seal body 906 is a ceramic or other rigid material. As an example, the use of ceramic for the seal body 906 allows for high temperature material handling without breaking down the seal. In order to obtain a desirable fit and performance, a high temperature rubber material or coating is applied to the vertical and/or horizontal surfaces of the seal body 906. The horizontal contact rubber coating 920 provides an interface with the nozzle body allowing for a tight seal when pressure is applied to the top of the seal body. The vertical contact rubber coating 922 provides an interface with the nozzle body along sidewalls to aid in alignment of the seal body 906 allowing the needle aperture 909 to be as aligned with the path of the needle as possible. The horizontal contact rubber coating 920 and the vertical contact rubber coating 922 coat the entire contact surface of the seal body 906. In other embodiments, the horizontal contact rubber coating 920 and the vertical contact rubber coating 922 coat less than the entire contact surface of the seal body 906. Coating the horizontal and vertical surfaces partially and leaving a gap where they interface, a similar situation is created as described with respect to FIG. 9A, where the flared portion 910 creates a spacing away from the corner where the seal body 906 is seated. By leaving a gap between the horizontal contact rubber coating 920 and the vertical contact rubber coating 922, the corner from the nozzle body is kept from sufficiently contacting the seal body 906 to negatively affect alignment of the needle aperture 909.

According to various embodiments, in order to create a high performance seal where the needle travels through the needle aperture 909, an abradable coating is applied to the needle (or the needle aperture). Nickel Graphite is an example of one such coating example. In operation, the friction between the coating and the needle aperture 909 will cause the coating to abrade away resulting in a high performance smooth seal.

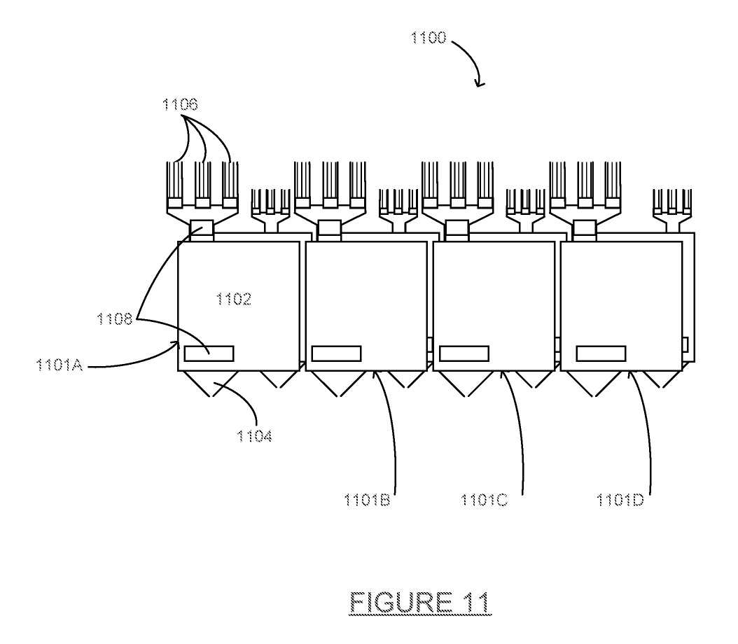

FIG. 10 is a diagram of a multiple-material, variable-control, nozzle system 1000 configured for variable control of multiple materials. The multiple-material, variable-control, nozzle system 1000 can include a nozzle body 1002, a nozzle tip 1004, a material delivery manifold 1006, material intakes 1008A-C, and control valves 1010A-C.

The multiple-material, variable-control, nozzle system 1000 can utilize the material delivery manifold 1006 to selectively allow for the flow of materials through the material intakes 1008A-C. Three material intakes 1008A-C are shown, however, additional intakes may be present according to various embodiments. Control valves 1010A-C allow or restrict flow of material from the material intakes 1008A-C through the material delivery manifold 1006 to the nozzle body 1002. As the design of an object being printed calls for a material transition, a first control valve 1010A can close and another, second control valve 1010B can open, allowing for continuous flow of material through the transition.

According to various embodiments, a first material is provided through a first material intake 1008A, and a second material is provided through a third material intake 1008C, while the second material intake 1008B provides a mixture of the two. The control valves 1010A-C operate in a programmatic fashion so as to allow the first material to flow to the nozzle body 1002 for printing, followed by the mixture (from the second material intake 1008B) and then to the second material. This allows for a transition from the first material to the second material with a transitional layer/portion between. This represents an example of how the multiple-material, variable-control, nozzle system 1000 can operate according to embodiments of the inventive subject matter. According to similar embodiments, functional grading of multiple materials (e.g. polyurethane and ethylene-vinyl acetate (EVA)) or material compositions/densities (e.g. EVA rubber, EVA foam or material combinations) is achieved through the flow control and on-the-fly adjustment of material composition. In an example embodiment, functional grading from 100% material A to 75% material B/25% material A is desired across a cross-section with a transition between. The transition may be linear or non-linear, and in fact the material rations may progress forward or backward through the transition. In order to achieve such characteristics, precise control over the material composition of the material flowing through the various material intakes 1008A-C, and in the control valve 1010A-C operation. Material A may be provided through the first material intake 1008A, with the next transition step material composition available in the next, or a second, material intake 1008B, say 90% material A, 10% material B. The third material intake 1008C is prepped with the next transition step material composition of 85% material A, 15% material B. As the print progresses and the control valves 1010A-C close and open successively to restrict one material intake and open another, the material compositions supplied to each material intake 1008A-C are adjusted. In this example with three material intake 1008A-C supplying the material delivery manifold 1006, once the first control valve 1010A is closed and material proceeds to be delivered from the second or third material intake 1008B-C, the material composition of the first material intake 1008A is adjusted so that when an additional material composition is needed (e.g. 50% material A, 50% material B), it can be accessed. The constant adjustment of the material intake supply while other intakes are operationally providing material flow allows for precision transition between material compositions.

According to various embodiments of the inventive subject matter, multiple control valves 1010A-C are opened simultaneously to allow for a mixed flow of material through the material delivery manifold 1006. The mixture ratio is determined by the material compositions in each material intake 1008A-C. Pure materials, for example, need not be the only way to mix—a 100% material A may be mixed with a 25% material B/75% material A composition to achieve the desired ratio and gradation. The pressure applied to each material intake 1008A-C and the flow control provided by the control valves 1010A-C also provide variable control over the mixture ratio between the material intakes 1008A-C. The control valves 1010A-C may provide flow control by opening less than fully, or by intermittently switching between open and closed states. The material delivery manifold 1006, according to some embodiments, includes a mechanism for agitating the material within, helping ensure a desired and consistent mixture ratio.

Temperature control plays a part in the material delivery system through the nozzle as well. The material intakes 1008A-C, the material delivery manifold 1006 and the nozzle body may each have variably controlled thermal characteristics. Heating and/or cooling mechanisms are used to control the temperature of the material flowing through each element. As the materials change or as the material compositions/mixtures change during the flow of material, the temperatures applied are changed in kind.

According to various embodiments, the material intakes 1008A-C may be used to deliver the same material/composition. To allow for precise pressure control, as the material in the first material intake 1008A is depleted, the material in the second material intake 1008B may be delivered to provide a smooth transition. This transition allows the first material intake 1008A to be refilled and properly pressurized (and temperature set as needed) for use after the second material intake 1008B has completed.

FIG. 11 is a perspective diagram of a multi-nozzle system 1100 having multiple nozzles for enhanced printing according to various embodiments. The multi-nozzle system 1100 includes multiple nozzle bodies 1102, each having nozzle tips 1104 and one or more material supply lines 1106 and temperature control elements 1108. The multiple nozzle bodies 1102 are arranged in a pattern such that one row is offset from the next. This allows for printing multiple lines of material in a layer with fewer x and y axis movements. Each nozzle body 1102 includes one or more material supply lines 1106 to supply a material or multiple types/compositions of materials to each nozzle body 1102 to be printed through the nozzle tips 1104. This arrangement allow for a single layer or a single pass of a print to both be done quickly and also include multiple varied material types/compositions.

Temperature control elements 1108 are attached to or integrated into various components of the multi-nozzle system 1100 in order to manage the temperature of material flowing through. The nozzle bodies 1102, nozzle tips 1104 and material supply lines 1106 may each include temperature control elements 1108. The temperature control elements 1108 may be heating elements according to various embodiments. According to other embodiments, temperature control elements include cooling elements additionally. As varying material is provided in different material supply lines 1106 and to different nozzle bodies 1102, the need to control temperature separately across each component is important. The temperature control elements 1108 are driven by print material data such that as the material through the various components (e.g. nozzle body 1102, nozzle tip 1104, material supply lines 1106 . . . ), the temperature needed to properly flow the material is adjusted accordingly.

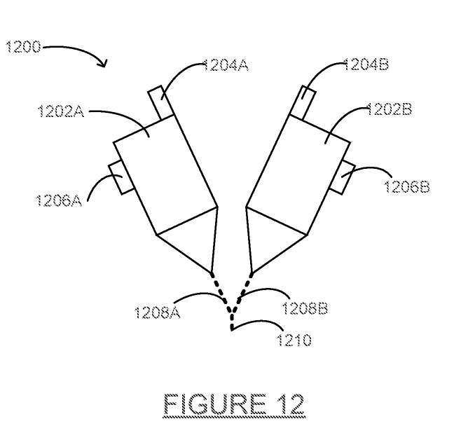

FIG. 12 is a block diagram of a deposition system 1200 utilizing post-nozzle mixing according to various embodiments. The deposition system 1200 includes a first deposition nozzle 1202A with a first control input 1204A and a first material inlet 1206A, and a second deposition nozzle 1202B with a second control input 1204B and a second material inlet 1206B.

The deposition nozzles 1202A-B arranged and aimed such that a first material stream 1208A exiting the first deposition nozzle 1202A will collide with a second material stream 1208B to form a mixed material stream 1210. According to various embodiments, multiple deposition nozzles 1202A-B are used to handle multiple materials separately or mixed combinations. The collision point between the material streams 1208A-B may be above a deposition surface, or the deposition nozzles 1202A-B can be angled to create the collision point at the desired point of deposition.

According to some embodiments, by varying pressure and volume (flow rate and velocity), varied concentrations of materials are mixed in this manner. For example, a 30% concentration of material A being mixed with a 70% concentration of material B may be delivered as follows: Material A is delivered in lower volume but at higher pressure, while material B is delivered at higher volume but lower pressure. This allows material A to be delivered with less material in the final concentration, but with sufficient force as to enable mixing, while material B is delivered with more material, but its lower pressure is compensated for by material A. A higher pressure being delivered from one deposition nozzle to the other may result in the mixed material stream 1210 being pushed in one direction or the other. This can be compensated by either accounting for the resultant angle of the mixed material stream 1210 or by adjusting the angle of one or more of the deposition nozzles 1202A-B. The angle adjustment can be done on the fly as concentrations and/or pressures are adjusted.

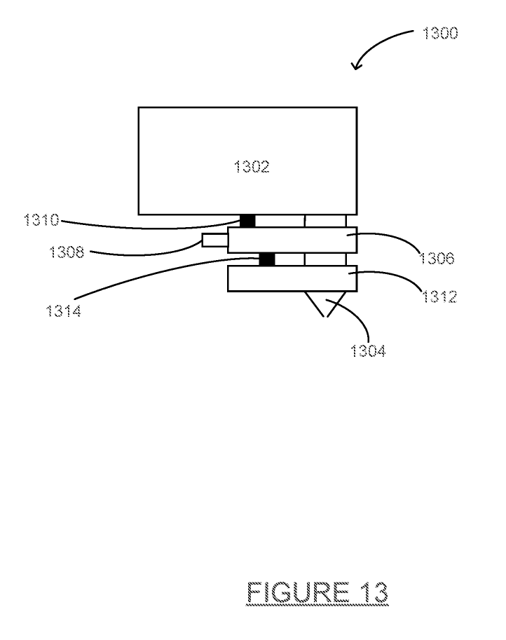

FIG. 13 is a diagram of a deposition nozzle 1300 with integrated heating and cooling according to various embodiments. The deposition nozzle 1300 includes a nozzle body 1302, a nozzle tip 1304, a material supply chamber 1306, a material inlet 1308, a body insulator 1310, a temperature control element 1312 and a material supply insulator 1314.

According to various embodiments of the inventive subject matter, the nozzle body 1302 houses (at least part of) an actuation element, which is used to selectively allow and restrict movement of material for deposition. The actuation element also serves to break up or atomize the material as it flows through the deposition nozzle 1300. This breaking up of the material as it flows through the nozzle tip 1304 helps thin the material in some circumstances, assisting deposition. The actuation element extends into the nozzle tip 1304 in order to perform the task of restricting and allowing material flow. A material supply chamber 1306 is connected to the nozzle tip 1304 to supply material for deposition. The material enters the material supply chamber 1306 through a material inlet 1308. The material supply chamber 1306 is temperature controlled to assist in material flow. A heating element in or in thermal communication with the material supply chamber 1306 is used to control the temperature of the material as it flows through the material supply chamber 1306. According to various embodiments, the temperature settings are adjusted based on the material/material composition being delivered to the material supply chamber 1306. In order to protect the nozzle body 1302 from excessive heat, a body insulator 1310 placed between the nozzle body 1302 and the heated material supply chamber 1306. The body insulator 1310 may be a low thermally conductive material applied across portions of the surfaces of the nozzle body 1302 and the material supply chamber 1306. Alternatively, the body insulator 1310 may be a small spacer that effects an air gap between the nozzle body 1302 and the material supply chamber 1306.

According to various embodiments, a temperature control element 1312 is present below the material supply chamber 1306. The temperature control element 1312 is mounted such that it sits between the heated material supply and the work surface. The material supply insulator 1314 provides thermal insulation between the material supply chamber and the temperature control element 1312. The temperature control element 1312 serves to restrict the heat that radiates from the material supply chamber 1306 to the material on the work surface. According to various embodiments, the temperature control element 1312 includes cooling features. The cooling features may include heat sinks, fans, compressed air delivery and/or liquid cooling. As an example, a liquid cooled temperature control element 1312 allows for controlled temperature management of the bottom side of the deposition nozzle 1300, which allows for better setting of materials being deposited. In the case of thermoplastics, the cooled temperature control helps ensure that movement of the deposition nozzle 1300 over printed material does not re-melt or deform the already deposited workpiece. The temperature control element 1312 includes liquid channels to deliver cooling liquid and a thermocouple/temperature sensor to feed back temperature data in order to maintain temperature control. The material supply insulator insulates 1314 the material supply chamber 1306 from the temperature control element 1312 with low thermally conductive material or an air gap to maintain efficient and controlled heating of the material supply chamber 1306 and cooling for the temperature control element 1312.

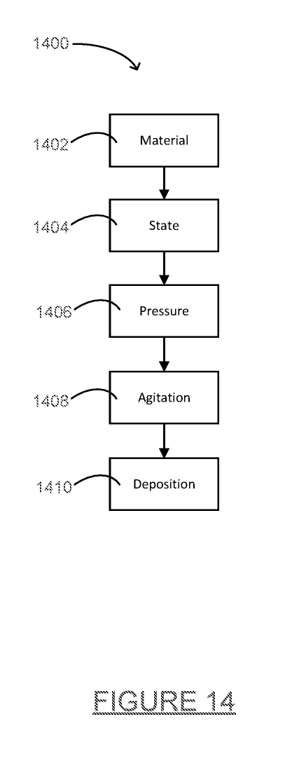

FIG. 14 is a flow diagram of an atomized deposition process 1400 according to various embodiments. To being, a material is provided and the characteristics of that material are determined (box 1402). Determination of the characteristics may be accomplished through a provided digital characteristic data relating to the material, or through sensors configured to acquire material characteristics to this end. Provided digital characteristic data may be gathered by processing the material through an external or parallel system and determining through the use of sensors in that system certain characteristics of the material which affect viscosity, flow rate, adherence and other characteristics at varying temperatures, pressures and agitation frequencies. The material characteristics may also represent the expected characteristics of a material combination if more than one material is being processed and deposited through the system.

Once the material characteristics are known, the material is heated to achieve a desired state (box 1404). The desired state is generally liquid form in order to effect movement of the material through the system for deposition. Pressure and heat are applied to the liquid material to push it out of a material reservoir and toward a deposition nozzle (or mixing point) (box 1406). The applied pressure (and heat in some circumstances) also serves to thin certain material types (non-Newtonian shear thinning). As the material moves toward deposition, agitation is applied (box 1408). This agitation serves two purposes—first to break up the viscous material, and second to actually facilitate the movement of the material out of the deposition nozzle to effect deposition (box 1410). Varying the agitation rate can control the flow rate of the material being deposited.

According to some embodiments of the inventive subject matter, object print speed is increased by including additional nozzles installed in parallel. This arrangement allows for the utilization of more nozzles to deposit a larger volume of material at a time while being able to scale back the nozzles being utilized on the fly in order to deposit lower volume, higher resolution details. The variation and speed gains all depend on the geometric shape, and material composition desired of the object being printed.

According to other embodiments, a deposition nozzle is used to deposit and layer particles with using increased deposition velocity (e.g. supersonic delivery speeds). This can be done with or without the addition of heat. In this manner, the impact force of on the polymers causes a bond between the deposited polymer and previously deposited polymers on the work surface. This mechanism may be used for atomized liquid or jetted powder material according to various embodiments.

Thus, example embodiments of the inventive subject matter are disclosed. One skilled in the art will appreciate that the present teachings can be practiced with embodiments other than those disclosed. Pneumatics and hydraulics are used as exemplary pressure sources, but it is considered that other pressure creating technologies may be used as well. Similarly, piezoelectric actuators, high pressure air, ultrasonic transducers and other agitation methods are used as an exemplary atomization element, but it is considered that agitation methods may be used as well. The disclosed embodiments are presented for purposes of illustration and not limitation, and the present teachings are limited only by the claims that follow.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

Additional embodiment: An atomized deposition system of comprising: multiple material supply chambers for separately holding a first and a second material; a first and a second pressurizing element in communication with the material supply chambers to provide pressure to separately move the materials; and a controller configured to selectively adjust the pressurizing elements based on characteristics of the materials.

Additional embodiment: An atomized deposition system wherein the controller is further configured to selectively adjust heating elements, actuation elements, and pressurizing elements based on characteristics of material combinations in the deposition nozzle.

Additional embodiment: An atomized deposition system comprising multiple deposition nozzles to selectively deposit material based on a desired deposition resolution and speed.

Additional embodiment: An atomized deposition system comprising a seal within the nozzle body, the seal providing a channel for movement of the nozzle needle, wherein the seal includes a horizontal exterior surface and a vertical exterior surface, the horizontal exterior surface and the vertical exterior surface having a tapered interface to avoid full contact between the tapered interface and the nozzle body.

1. An atomized deposition system comprising:
a deposition nozzle for receiving material under pressure, the deposition nozzle including a nozzle tip for the material to exit the deposition nozzle;
a heating element in communication with the deposition nozzle to provide heat to the material;
an actuation element in communication with the material in the deposition nozzle to allow movement of the material out of the deposition nozzle though the nozzle tip;
a controller to control the heating element and the actuation element, wherein the controller adjusts a temperature of the heating element in response to characteristics of the material, further wherein the controller adjusts a frequency of the actuation element in response to deposition specifications; and
a pressurizing element to apply pressure to the material, wherein the controller configured to selectively adjust the heating element, actuation element, and pressurizing element based on a deposition resolution and speed.

2. The atomized deposition system of claim 1, wherein the actuation element is selected from a group comprising: piezoelectric, pneumatic, sonic, ultrasonic, thermal and acoustic.

3. The atomized deposition system of claim 1, further comprising a nozzle needle in communication with the actuation element to selectably restrict the material from flowing through the nozzle tip.

4. The atomized deposition system of claim 1, further comprising:
a material supply chamber for holding a material; and
a pressurizing element in communication with the material supply chamber to provide pressure to move the material through the deposition nozzle; and
wherein the controller is configured to adjust the pressurizing element based on characteristics of the material.

5. The atomized deposition system of claim 4, wherein the pressurizing element is configured to provide pressure to the material to decrease a viscosity of the material, allowing the actuation element to atomize the material more easily.

6. (canceled)

7. A material deposition device for depositing material onto a surface, the material deposition device comprising:
a nozzle body including a fluid inlet and a control input;
a nozzle tip in fluid communication with the fluid inlet, the nozzle tip including a deposition aperture;
a needle at least partially disposed within the nozzle tip;
an actuator within the nozzle body and connected to the control input, the actuator operable to move the needle to restrict movement of fluid through the deposition aperture;
a heating element in communication with the nozzle body and connected to the control input, the heating element to heat the fluid from the fluid inlet;
a controller connected to the control input; the controller configured to adjust the temperature of the heating element and to adjust the frequency of the actuation of the actuator and
a seal about the needle and positioned within the nozzle body to allow movement of the needle while restricting fluid movement from a first side of the seal to a second side of the seal.

8. The material deposition device of claim 7, wherein the controller is composed of multiple control circuits.

9. The material deposition device of claim 7, wherein the control input is composed of multiple connections.

10. (canceled)

11. The material deposition device of claim 7, further comprising a cooling element, the cooling element having at least partial thermal isolation from the heating element, the cooling element positioned between the heating element and the surface.

12. The material deposition device of claim 11, wherein the cooling element uses liquid cooling.

13. The material deposition device of claim 11, wherein the controller is configured to control the temperature of the cooling element.

14. A method of depositing material onto a surface based on an object design, the method comprising:
receiving fluid material under pressure at a nozzle;
controlling the temperature of the material in the nozzle;
actuating a valve at a frequency to control flow of the material out of the nozzle;
receiving object input regarding characteristics of the object design;
adjusting the temperature of the material in the nozzle based on the object input;
adjusting the frequency of the actuating based on the object input; and
depositing the material to create a physical object based on the object design.

15. The method of claim 14, further comprising:
receiving material input regarding the material in the nozzle,
adjusting the temperature of the material in the nozzle based on the material input; and
adjusting the frequency of the actuating based on the material input.

16. The method of claim 15, wherein the material input includes one or more characteristics of the material selected from the group consisting of: composition, viscosity, temperature, and flow rate.

17. The method of claim 14, further comprising:
receiving print input regarding the physical object,
adjusting the temperature of the material in the nozzle based on the print input; and
adjusting the frequency of the actuating based on the print input.

18. The method of claim 14, further comprising adjusting the pressure applied to the material in the nozzle based on the object input.

19. The method of claim 14, wherein the characteristics of the object design include one or more elements selected from the group consisting of: object shape, object density, object material composition, print speed, print resolution, and layer height.

20. The method of claim 14, further comprising shielding the deposited material on the surface with a cooling element positioned between a portion of the nozzle and the surface.

21. The method of claim 14, further comprising thinning the material by actuating the valve at a predetermined frequency.
